(19) United States
(12) Patent Application Publication
(10) Pub. No.: US 2021/0258317 A1
(43) Pub. Date: Aug. 19, 2021

(54) IDENTITY VERIFICATION SYSTEM AND METHOD

(71) Applicant: Deana Kreitz, Houston, TX (US)

(72) Inventor: Deana Kreitz, Houston, TX (US)

(21) Appl. No.: 16/795,349

(22) Filed: Feb. 19, 2020

(51) Int. Cl. H04L 29/06; G06N 20/00; G06N 5/04; G06K 9/00

(52) U.S. Cl. CPC H04L 63/102; H04L 63/0861; G06N 20/00; G06K 9/00711; G06K 9/00288; G06K 9/00281; G06N 5/04

(57) ABSTRACT

A system and method of identity verification for a user includes an electronic device configured to permit a user to create a profile wherein the profile is tied to an electronic device through at least one device identifier. The profile is also tied to a particular person through one or more user identifiers focused on gestures, movement, pictures and so forth. These are processed in accordance with at least one of artificial intelligence technology, voice analysis, motion sensing, and third parties to compare the identity of the current user to the stored user. The system requires near-time capturing of information upon log in. As the captured user identifiers extend to voice, movement, and appearance of the user, it is more difficult to scam the system and fake a profile.

### BACKGROUND OF THE INVENTION

### 1. Field of the Invention

The present application relates to a software program executed through an electronic device for the verification of user identity, and more particularly to a method of verifying the accuracy of a user's identity based upon near-time captured physical or audible data to regulate communications between two or more parties through the electronic device.

### 2. Description of Related Art

Commonly, people are meeting, socializing and dating through online services, such as software applications and networking platforms. Typically, each online service requires a user to create a profile. Information required can vary, but generally some personal data like a name, address, and a photo is all that is needed. Sometimes an age and gender are required as well.

A problem with these online services is that this information is not verified and can be easily forged. None of them ask the user to provide social security or drivers licenses or any official government ID. This lack of an online identification validation system is what allows scammers to create multiple accounts and pose as people they are not. These scammers range from as harmless as people who want to trick someone into liking them but pose as a different person, to as dangerous as a person who is attempting to steal money from other users or trying to physically harm other users. Some social platforms are attempting to cut down on this occurring on their platforms by asking for a photo with a gesture validation, but this can also be rigged. The need for security has long passed the use of passwords and has needed to develop into a multifactor verification using near-time data captures.

People can catfish/scam by posing as another person on social platforms relatively easily. This involves taking another person's photos and info, typically from social media accounts. The person can have multiple accounts out there with one person's face all the while not actually being that person.

Although strides have been made, shortcomings remain. It is desired that a system and method be provided that requires users to validate their identity in a manner that confirms the person is real and reduces or eliminates catfishing and scamming through the theft and use of others pictures and names. This goes beyond arbitrary numbers and pins as passwords and requires the person themselves to be the verification key.

### BRIEF SUMMARY OF THE INVENTION

It is an object of the present application to create a credible online identity verification system through use of a variety of AI technologies. This can be seen through native mobile technologies for example. This verification system can be used by other systems to ensure users are real and let other users know the users are real people. The system and method is configured to utilize physical and/or verbal cues from a user to validate their identity. Such cues are taken in near-time and compared with stored profile identifiers. As a whole, the system and method is useful to eliminate scamming and false identities online to help create a safer communication platform.

It is a further object of the present application that a method of verifying the identity of a user via an electronic device is developed. This method involves creating a user profile within a software application in the electronic device. The user then completes a device validation task to associate a particular electronic device with a particular profile. The electronic device is given a unique ID. A user also creates a user validation to verify the identity of the user using the electronic device. Upon use of the application, the user is then required to validate their identity by providing a user identifier. This is compared to such identifiers on file with the profile. Once performed, communicating with a remote party through the electronic device may occur.

An object of the present application may include the system and method using facial recognition software, artificial intelligence technology, verbal sound analysis, pictures, and motion as identifiers of the user all assessed in near-time in comparison with such corresponding identifiers as designated in the profile on the system.

Another object is to limit catfishing and scamming by correlating a particular electronic device to a particular profile. A single profile may be associated with a number of electronic devices. However, a single electronic device may be associated with only a single profile per software application.

Additionally, the system and method may require 2 stage near-time verification using a plurality of identifiers of the potential user with a profile. One such identifier may be randomly selected by the system.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a chart illustrating a method of using an identity verification system according to an embodiment of the present application.

FIG. 2 is a chart showing the relationship of a user profile and one or more electronic devices used in the identity verification system of FIG. 1.

FIG. 3 is a chart of user identifiers suitable for user validation of a user in the identity verification system of FIG. 1.

FIG. 4 is a chart of sample system hardware and structure to operate the identity verification system of FIG. 1.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

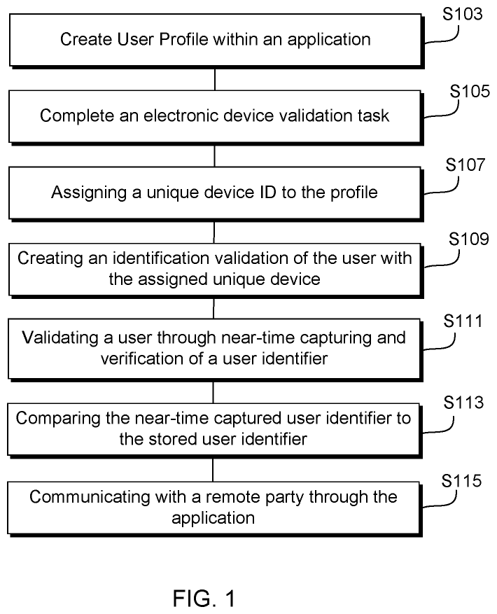

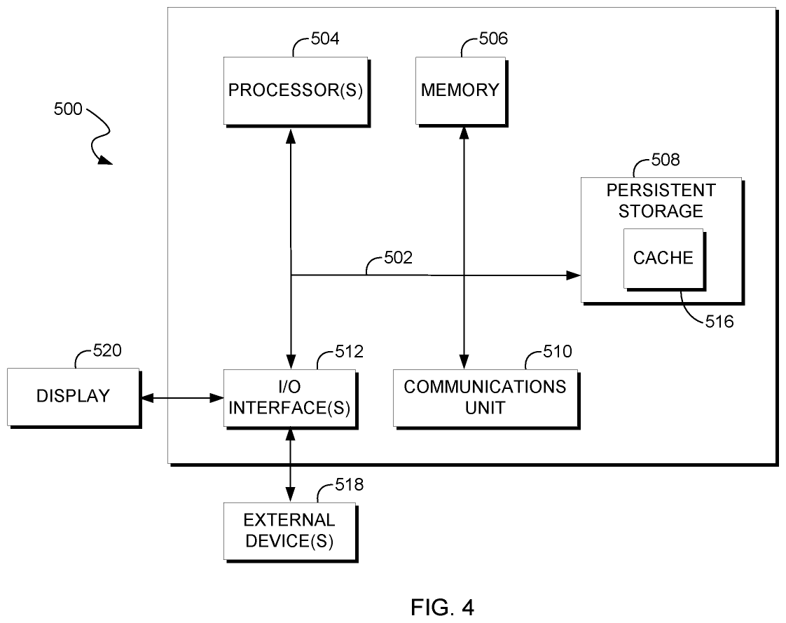

Referring now to FIG. 1 in the drawings, a chart illustrating a method of using an identity verification system is provided. This method is executable and operable through one or more electronic devices, an example of which is provided with FIG. 4. It is understood that software or programming may be required to execute such steps within the method of FIG. 1. The system of the present application is configured to eliminate scamming and catfishing prevalent on online social media and other platforms wherein people can almost assume any identity desired by lying when setting up the profile. The system is configured to utilize near-time collected user identifiers to compare to profile collected and stored user identifiers to assess and verify the identity of the user. This helps to give assurances that the person on the electronic device is actually the person associated with the profile. By using visually captured data or identifiers, a remote party can be assured that the person they are communicating with is actually the person in the profile posted. The system may be configured to utilize two-step or multifactored verification that goes beyond the passwords to use more visual near-time captures of the user.

As seen in FIGS. 1-3, a method and features of verifying the identity of a user via an electronic device is shown. The user first creates a profile (S103) within the platform through an electronic device. The platform will contain one or more software applications to carry out the processes and functions of the system. The profile may include conventional data such as name, age, gender, user ID, and a password for example. The user also includes a picture of the user. The profile information is stored in the backend of the system for recall and use at later times. Ideally such picture is of a nature sufficient to capture their face. This picture is used as a profile user identifier and will be used during the validation step to verify user identity.

A feature that sets the present system and method apart from legacy systems is the optional use of artificial intelligence technology that can be used to identify facial characteristics from a photo of the user. The technology may be used with facial recognition software. The program of the present application can adapt and learn from the motions, appearance fluctuations, and environment of the user and automatically adapt such to accurately assess identity.

The user also completes a device validation task (S105) configured to associate an electronic device with the user profile. The system is configured to utilize the native features of the electronic device including at least any of an accelerometer; a compass; an altimeter; and a sensor. The task may require the use of phone calibration sensors. Once this is completed, the electronic device is assigned a unique ID (S107) and such ID is correlated to a particular user profile.

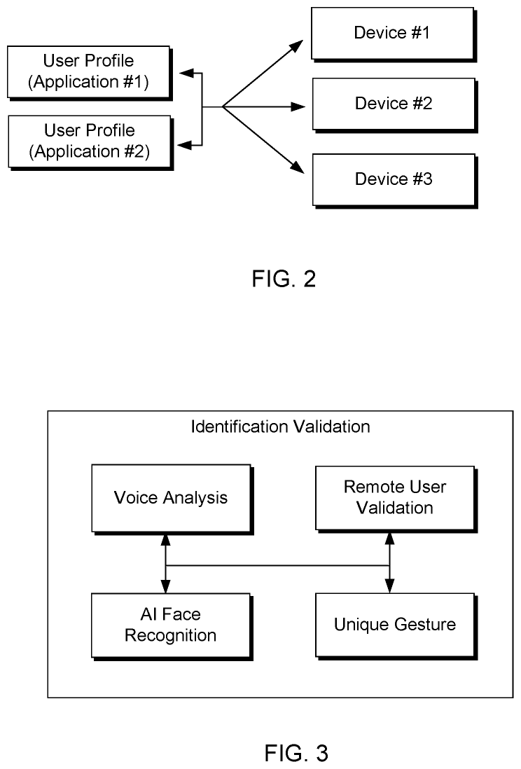

As seen in FIG. 2, it is desired that a single profile may be associated with any number of electronic device IDs, but only where an electronic device may be associated with a single profile. This is applicable for each application using the program as many different software applications may use the verification system of the present application. For example, a dating application may be able to use the verification method of the present system and assign devices to a particular unique profile. Likewise, a secondary application may use the verification system of the present application on the same devices, it being assigned to a separate unique profile. Each profile is a combination of the particular software application using the verification system and the device on which it is being run from. This is designed to prevent situations where a single device is used by a person within the same application to assume multiple identities through different accounts. It is understood that the system of the present application may not require such limitations on the electronic devices in some embodiments.

A user also creates or sets up a user validation with one or more user identifiers (S109). These user validation identifiers are used as a baseline or password so to speak for permitting or regulating user access. For example, the user uploads a picture of him/herself. The system processes or analyzes the picture in near-time to capture facial characteristics or other unique features of the user. Other user identifiers may be motion gestures, verbal/voice recordings or even a remote user validation through a 3^{rd} party (see FIG. 3). These “profile” user identifiers are stored and used by the system for comparison to future captured user identifiers for the purpose of regulating access.

When used or accessed by a user, the user is prompted to provide a current user identifier that will be compared with a profile user identifier. This is part of validating the identity of the user (S111). These current user identifiers are compared to the profile user identifiers to validate the identity of the user trying to access the system. It is preferred that the system uses two separate identifiers for validation such that a multifactored validation occurs. Additionally, it is possible that the system is configured to randomly select which current user identifier is necessary. Much like the profile user identifiers, the current user identifiers may include the use of at least one of voice analysis, artificial intelligence recognition, a unique gesture, and a remote user validation.

A feature of the system is the need or desire to assess that the pictures or person is who they purport to be. Therefore, the system could utilize voice recognition software wherein the user is required to repeat a set of words to assess voice characteristics. The requirement of picture analysis through artificial intelligence and/or facial recognition is possible to ensure that the person looks the way they purport to look. A gesture or movement of the body captured through video on the electronic device is just another example of a way to ensure real people using the device and not fake people.

The feature of requiring the user to take or capture such current user identifiers in near-time is a way to ensure that the identifiers used to “log in” to the application are not doctored up or modified. Another feature is that the near-time capturing be done through the electronic device associated with the profile. This means that pictures taken from another device can not be used and merely uploaded. The device of record with the profile is needed to capture the near-time picture. Similar application goes for the other types of user identifiers.

The current user identifier is processed and compared to the profile user identifiers (S113). Artificial intelligence technology may be used to assist in processing and comparing user identifiers. Where a remote third party is used to validate identity, a video, voice or picture of the user may be sent to the third party, thereby allowing them to use their eyes and ears to validate the identity of the user. Additionally, the artificial intelligence technology may be used to scan through all or some profiles to ensure that the same profile data or identifiers are not used across multiple profiles.

It is understood that some users are potentially identical twins. In such situations, the physical and vocal appearance of the users may be indistinguishable to the naked eye. Artificial intelligence, voice analysis software, and facial recognition software would be extremely helpful is assessing potential differences. Where and if such differences are not possible, the system is able to still rely on manual passwords and third party validations.

Once the user is validated, the user may use the system to communicate with a remote party through the electronic device (S115). As a further safety precaution, the system may require the user to revalidate their identity upon the initiation of a subsequent communication with another remote party. Revalidation may occur to start a new communication or to begin anew or restart an existing conversation, for example after a period of inactivity.

It should be known that apart from the described types of user identifiers, a user may vocalize or perform a series of gestures which act as a pin or password of sorts to access the software under a particular profile. Movement data profiles, voice data profiles, and physical feature profiles may be collected.

FIG. 4 depicts a block diagram of components of a computing system (electronic device) configured to support the method and operation of the identity verification system of the present application. It should be appreciated that FIG. 4 provides only an illustration of one implementation of system components and does not imply any limitations with regard to the environments in which different embodiments can be implemented. Many modifications to the depicted environment can be made. For purposes here, online services executable or operable through the methods of the present invention may correspond to any one of software program instructions, software platforms, program data and so forth.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Computer system 500 includes communications fabric 502, which provides communications between cache 516, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses or a crossbar switch.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast storage that enhances the performance of computer processor(s) 504 by holding recently accessed data, and data near accessed data, from memory 506.

Programming used to carry out the functions and features illustrated through the method of FIG. 1 may be stored in persistent storage 508 and in memory 506 for execution by one or more of the respective computer processors 504 via cache 516. In an embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Software and programing for the online services may be downloaded to persistent storage 508 through communications unit 510.

I/O interface(s) 512 allows for input and output of data with other devices that may be connected to server computer 102, player device 104, and/or collector device 106. For example, I/O interface 512 may provide a connection to external devices 518 such as a keyboard, keypad, a touch screen, a microphone, and/or some other suitable input device. External devices 518 can also include portable computer readable storage media such as, for example, thumb drives, portable optical or magnetic disks, and memory cards. Software and data used to practice embodiments of the present invention, e.g., online services, can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A method of verifying the identity of a user via an electronic device, comprising:
creating a user profile within a software application in the electronic device;
completing a device validation task configured to associate the electronic device with the user profile;
assigning a unique electronic device ID to the user profile, the electronic device ID being used to identify the electronic device;
creating a user validation to verify the identity of the user using the electronic device;
validating a user identity by providing a user identifier in order to access the user profile, the user required to satisfy the user identifier; and
communicating with a remote party through the electronic device.

2. The method of claim 1, further comprising:
uploading a video of the user to create a profile.

3. The method of claim 2, wherein the software application incorporates artificial intelligence technology to identify facial characteristics from the video particular to the user.

4. The method of claim 3, wherein the user validation includes capturing a near-time video of the user with the electronic device associated with the electronic device ID; and analyzing the near-time video to the uploaded photo for the user and comparing facial characteristics to validate the identity of the user.

5. The method of claim 1, wherein the device validation task uses native features of the electronic device including at least any of an accelerometer; a compass; an altimeter; and a sensor.

6. The method of claim 1, wherein the electronic device ID is collected from the electronic device and stored with the user profile.

7. The method of claim 1, wherein the user profile is configured to be associated with a one or more electronic devices.

8. The method of claim 7, wherein the electronic device is configured to be associated with only a single user profile.

9. The method of claim 1, wherein the electronic device is configured to be associated with only a single user profile.

10. The method of claim 1, wherein the user validation includes capturing a near-time video of the user with the electronic device associated with the electronic device ID.

11. The method of claim 10, further comprising:
analyzing the near-time video to the uploaded video for the user and comparing facial characteristics within each video to validate the identity of the user.

12. The method of claim 1, wherein the user verification is based on at least two user identifiers.

13. The method of claim 12, wherein the software application randomly selects at least one user identifier.

14. The method of claim 1, wherein the user identifier includes at least one of voice analysis, artificial intelligence recognition, a unique gesture, and a remote user validation.

15. The method of claim 1, wherein the user must revalidate the user identity to communicate with each remote party.

16. A method of regulating communication between parties through an electronic device, comprising:
creating a user profile within a software application in the electronic device;
associating the electronic device with the user profile, the user being required to complete a device validation task with the device, the electronic device being assigned an electronic device ID;
creating a user validation to verify the identity of the user using the electronic device, the user validation including at least one user identifier, the user identifier being associated with the user profile; and
validating a user identity by capturing a current user identifier in order to access the user profile, the current user identifier being compared to the profile user identifier;
wherein the current user identifier and the profile user identifier are configured to rely on at least one of voice analysis, artificial intelligence technology, a unique motion gesture, and a remote user validation.

17. The method of claim 16, further comprising:
communicating with a remote party through the electronic device; and
revalidating the user identity to communicate with a subsequent remote party.

18. The method of claim 16, wherein the software application randomly selects at least one current user identifier.

19. The method of claim 16, wherein the user profile is configured to be associated with a one or more electronic devices but the electronic device is configured to be associated with only a single user profile.

20. The method of claim 16, wherein the device and the user identity are associated with a particular profile, the identity of the user being ascertained through a two-part user verification.
